(19) United States
(12) Patent Application Publication
(10) Pub. No.: US 2009/0023314 A1
(43) Pub. Date: Jan. 22, 2009

(54) ELECTRICAL CONNECTOR AND ELECTRICAL CONNECTING DEVICE USING THE SAME

(75) Inventor: Ted JU, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD

(21) Appl. No.: 12/115,964

(22) Filed: May 6, 2008

(30) Foreign Application Priority Data
Jul. 17, 2007 (CN) 200720054245.8

(51) Int. Cl. H01R 12/00

(52) U.S. Cl. 439/83

(57) ABSTRACT

An electrical connector comprises: an insulating body having at least one containing hole; at least one binding pad disposed on the bottom of the insulating body near at least one side of the containing hole; and at least one terminal correspondingly disposed in the containing hole. Wherein the terminal comprises a soldering portion provided with solder and protruding out of the bottom of the containing hole, and a solder retaining area for retaining the solder is formed between the soldering portion and the binding pad. The solder retaining area can retain more solder near the soldering portion of the terminal to solder the terminal to a circuit board efficiently, so as to improve the quality of soldering and ensure fine electric conductivity.

### BACKGROUND OF THE INVENTION

1. Field of the Invention

The invention relates to an electrical connector for connecting two electrical devices and an electrical connecting device using the electrical connector.

2. Description of the Prior Art

At present, an electrical connector for connecting two electrical devices (such as a chip module and a circuit board, an electrical card and a circuit board, or two circuit boards) generally includes an insulating body and conductive terminals disposed in the insulating body. Generally, there are two major ways for the electrical connector to connect one of the electrical devices (such as a circuit board), and one is that the conductive terminals of the electrical connector directly compress and contact contacting pads disposed on the electrical device respectively, and another one is that soldering portions of the conductive terminals of the electrical connector are directly soldered with the contacting pads of the circuit board respectively. For high requirement for the conductive terminals of the electrical connector, the former method is not adopted widely in business, and in other words, most of the electrical connectors adopt the later method of connecting with the electrical device. As shown in FIG. 1 and FIG. 2, an electrical connector 1 includes an insulating body 10 and a plurality of terminals 12 disposed in containing holes 11 of the insulating body 10 respectively. The terminal 12 has a fixing portion 120 fixed in the insulating body 10, a soldering portion 121 extending from one end of the fixing portion and soldered with a circuit board 13, and an elastic contacting portion 122 extending from the other end of the fixing portion and capable of contacting with an electrical device (not shown). The soldering portions 121 are respectively provided with solder 14 thereon corresponding to the contacting pads 131 disposed on the circuit board. The electrical connector is soldered with the circuit board 13 through melting the solder. However, the technique still has following shortcomings: a distance L (as shown in FIG. 2) is formed between the bottom end of the soldering portion 121 and the contacting pad 131 of the circuit board 13 after being soldered, and the solder 14, which has lower electric conductivity than that of the terminals (formed by stamping a metal plate such as a copper plate) and locates between the bottom end of the soldering portion 121 of the terminal 12 and the contacting pad 131 of the circuit board 13, will increase the resistance between the terminal and the circuit board, and the quality of conductivity will be influenced. As shown in FIG. 3 and FIG. 4, another electrical connector 1′ is directly soldered on the circuit board, and the difference between the electrical connector 1′ and the electrical connector 1 is: the bottom end of the fixing portion 120′ protrudes downward directly to form the soldering portion 121′. When solder the electrical connector 1′ to the circuit board 13′, the soldering portion 121′ can be aimed to the contacting pad 131′ directly, and then the solder 14′ is melted through a heating process to connect the soldering portion 121′ of the terminal 12′ and the contacting pad 131′ of the circuit board 13′ together, so as to solder the electrical connector 1′ on the circuit board 13′. The distance between the bottom end of the soldering portion 121′ and the circuit board 13′ is short, so the above-mentioned shortcoming existing in the electrical connector 1 can be overcame. However, another problem exists. Because less solder adheres to the soldering portion of the terminal of the electrical connector, insufficient soldering is easily caused (i.e., some terminals may not be soldered with the circuit board because of insufficient solder, which results in broken circuit between the terminals and the circuit board) or the strength of soldering is not enough, which influences the quality of soldering and the conduction between the electrical connector and the circuit board.

Therefore, a novel electrical connector is needed for overcome the above-mention shortcomings.

### SUMMARY OF THE INVENTION

A scope of the invention is to provide an electrical connector capable of improving quality of soldering and ensuring fine electric conductivity.

To reach the scope, the electrical connector of the invention comprises an insulating body having at least one containing hole; at least one binding pad disposed on the bottom of the insulating body near at least one side of the containing hole; and at least one terminal correspondingly disposed in the containing hole. The terminal comprises a soldering portion provided with solder and protruding out of the bottom of the containing hole, and a solder retaining area for retaining the solder is formed between the soldering portion and the binding pad.

An electrical connecting device using the electrical connector comprises: an electrical connector comprising an insulating body having at least one containing hole, at least one binding pad disposed on the bottom of the insulating body near at least one side of the containing hole, and at least one terminal correspondingly disposed in the containing hole and comprising a soldering portion provided with solder and protruding out of the bottom of the containing hole; and an circuit board, having at least one contacting pad corresponding to the soldering portion of the terminal, for connecting the electrical connector. A solder retaining area for retaining the solder is formed among the binding pad, the soldering portion, and the contacting pad.

Compared with the prior art, the electrical connector of the invention is provided with the binding pad on the bottom of the insulating body and the solder retaining area formed between the soldering portion of the terminal and the binding pad. The solder retaining area can retain more solder near the soldering portion of the terminal and used to solder the terminal to the circuit board efficiently, which improves the quality of soldering and ensures fine electric conductivity.

The advantage and spirit of the invention may be understood by the following recitations together with the appended drawings.

### BRIEF DESCRIPTION OF THE APPENDED DRAWINGS

FIG. 1 is a partial cross-section view illustrating an electrical connector in the prior art.

FIG. 2 is a schematic diagram illustrating that the electrical connector in FIG. 1 is soldered on a circuit board.

FIG. 3 is a partial cross-section view illustrating another electrical connector in the prior art.

FIG. 4 is a schematic diagram illustrating that the electrical connector in FIG. 3 is soldered on a circuit board.

FIG. 5 is a perspective partial section view illustrating the electrical connector of the invention.

FIG. 6 is a schematic diagram illustrating that solder is disposed on the electrical connector in FIG. 5.

FIG. 7 is a schematic diagram illustrating that the electrical connector in FIG. 6 is soldered on a circuit board.

FIG. 8 is a partial enlarged view of FIG. 7.

FIG. 9 is a cross-section view illustrating that the electrical connector of the invention is connected to a chip module.

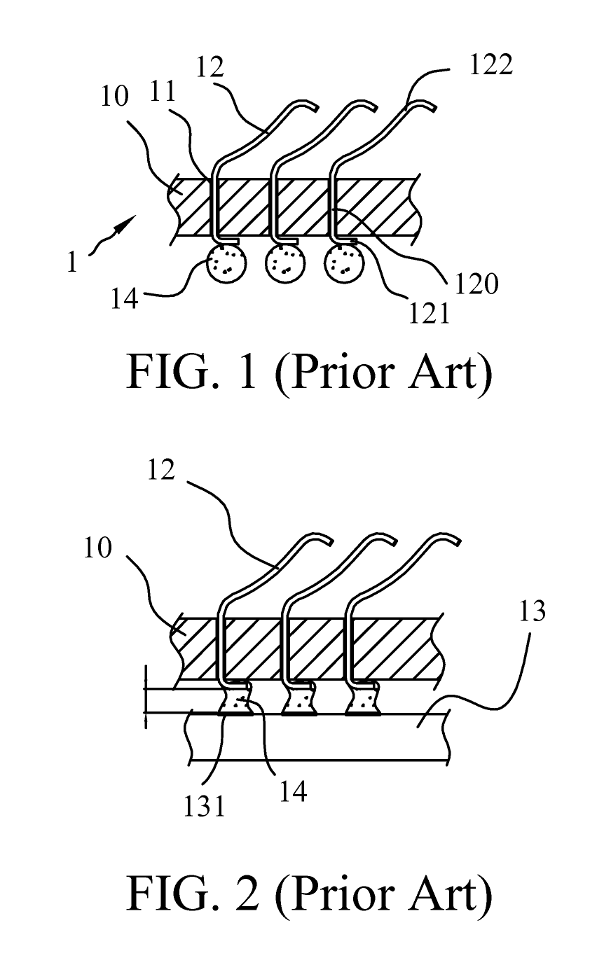

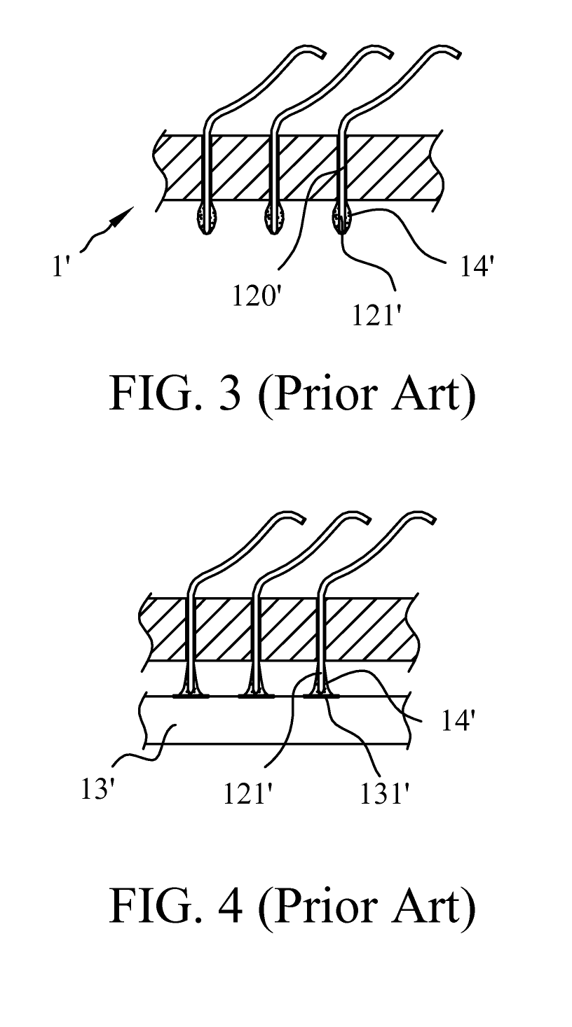

### DETAILED DESCRIPTION OF THE INVENTION

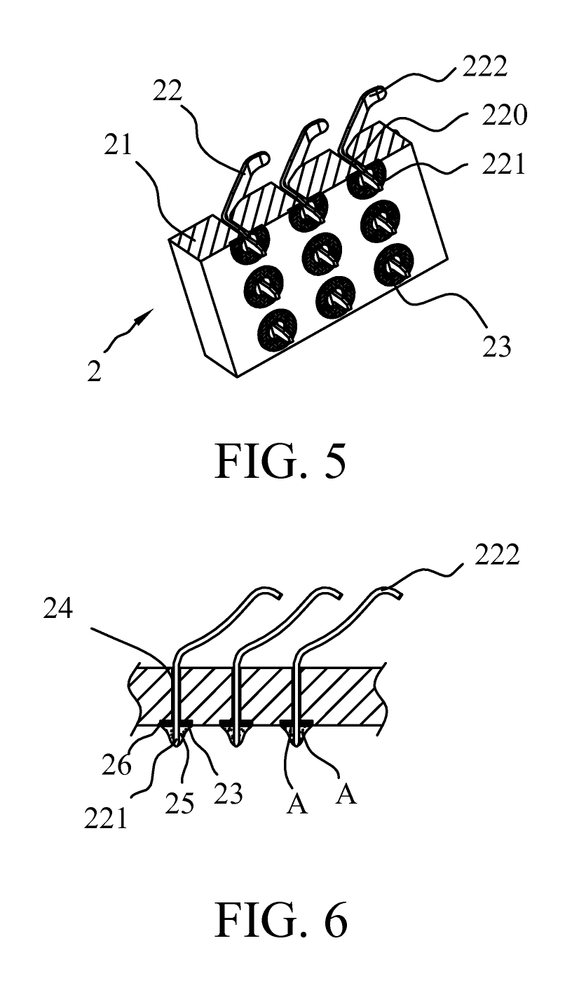

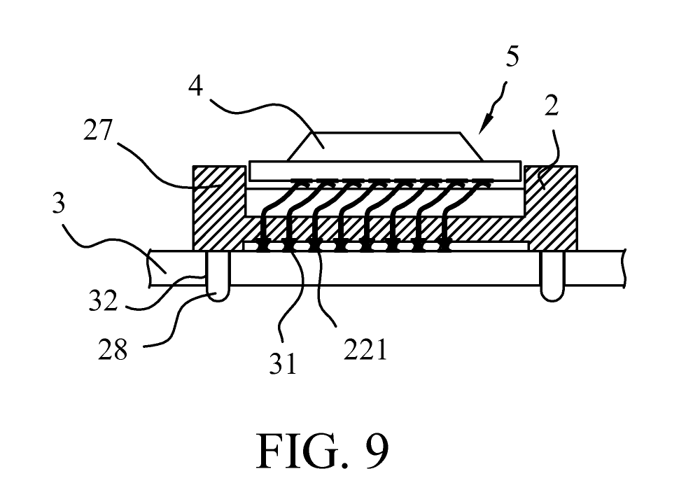

Please refer to FIG. 5 to FIG. 7. As shown in FIG. 5 to FIG. 7, an electrical connector 2 of the invention can be utilized for receiving a chip module (not shown) and connecting a circuit board 3 to provide electrical connection between the chip module and the circuit board 3. The electrical connector 2 includes an insulating body 21, at least one terminal 22, and at least one binding pad 23. The insulating body 21 has containing holes 24 in a matrix arrangement (the number of the terminal, is the same as that of the binding pad and the containing hole 24). The terminal 22 is correspondingly disposed in the containing hole 24, and the contacting pad 23 is disposed on the bottom of the insulating body 21 near at least one side of the containing hole 24. In the embodiment, a recess 26 interconnecting with and surrounding the containing hole 24 is disposed at the bottom of the containing hole 24. The binding pad 23 is continuous and disposed in the recess 26. Certainly, the binding pads 23 can be disposed on one side or both sides of the containing holes only or other predetermined positions near the containing holes. In the embodiment, the binding pad 23 is a metal sheet. Certainly, the binding pad 23 can be made of other materials capable of sticking the solder. The integral height of the electrical connector can be decreased efficiently because the binding pad is disposed in the recess 26. The terminal 22 includes a fixing portion 220 fixed in the containing hole 24 of the insulating body. The bottom end of the fixing portion 220 protrudes directly to form a soldering portion 221 protruding out of the bottom of the containing hole 24. The distance between the bottom end of the terminal and the bottom of the containing hole is large. Another end, opposite to the soldering portion 221, of the fixing portion extends to form an elastic contacting portion 222, and the contacting portion 222 can contact an external electrical device (the chip module 4 in FIG. 9). A solder retaining area denoted by A as shown in FIG. 6 and for retaining the solder 25 is formed between the soldering portion 221 of the terminal and the binding pad 23. The binding pad 23 together with the soldering portion 221 of the terminal can stick the solder 25 so as to make more solder to be retained in the solder retaining area A.

During soldering the electrical connector 2 to the circuit board 3, the electrical connector 2 is placed on the circuit board 3 and the soldering portion 221 provided with the solder 25 aims to the contacting pad 31, and then the solder 25 is melted through a heating process to connect the soldering portion 221 of the terminal to the contacting pad 31 of the circuit board, so as to solder the electrical connector 2 to the circuit board 3.

Please refer to FIG. 9. The electrical connector 2 of the invention further includes a positioning frame 27 extends upward from the surrounding of the insulating body. The positioning frame 27 is used for locating the chip module 4 into the electrical connector. Part of the bottom of the insulating body of the electrical connector protrudes downward to form at least one positioning pillar 28, and a positioning hole 32 is disposed on the circuit board 3. When the electrical connector 2 is installed on the circuit board 3, the positioning pillar 28 is positioned in the positioning hole 32. The configuration of the positioning pillar 28 and the positioning hole 32 enables the soldering portion 221 of the terminal and the contacting pad 31 of the circuit board to aim to each other quickly.

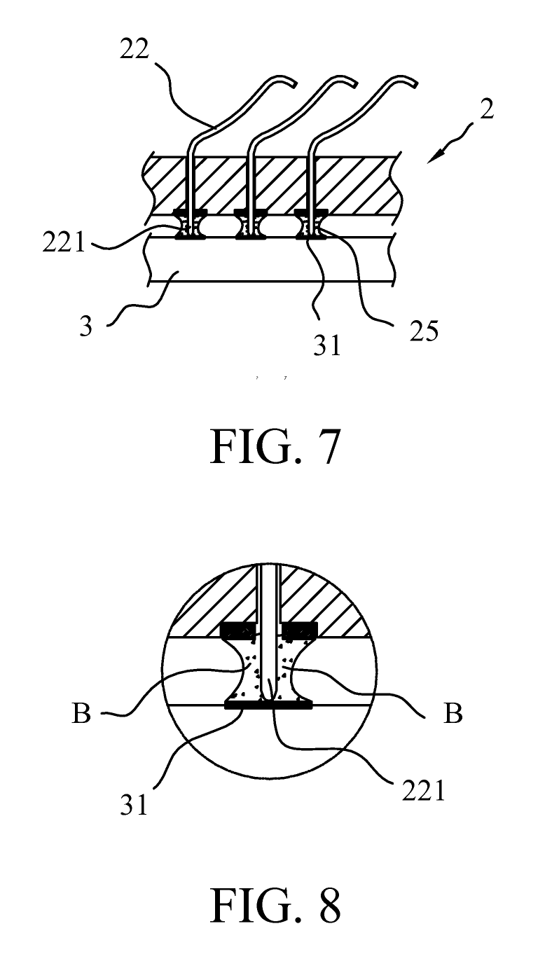

As shown in FIG. 7 to FIG. 9, the electrical connecting device 5 of the invention includes the electrical connector 2 and the circuit board 3. The binding pad 23 of the electrical connector 2 together with the contacting pad 31 of the circuit board 3 and the soldering portion 221 of the terminal 22 form a solder retaining area denoted by B as shown in FIG. 8, and because of the configuration of the binding pad 23, enough solder is retained in the solder retaining area B to ensure that the electrical connector 2 is efficiently soldered to the circuit board 3.

The electrical connector of the invention is provided with a metal binding pad 23 at the edge of the containing hole. The binding pad 23 together with the soldering portion 221 of the terminal form a solder retaining area A for retaining the solder, and the configuration of the binding pad disposed at the surrounding of the containing hole makes the solder retaining area A bigger. The solder retaining area A retains more solder therein and makes the terminal to stick enough solder, so as to ensure enough solder during soldering the electrical connector to the circuit board, and to avoid the problem existing in the later electrical connector in the prior art. On the other hand, the short distance between the bottom end of the soldering portion and the circuit board can avoid the problem existing in the former electrical connector in the prior art. At the same time, a recess for containing the binding pad, interconnecting with the containing hole is disposed at the bottom of the containing hole, so as to make the integral height of the electrical connector become relatively lower than that of the prior art.

The binding pad 23 and the soldering portion 221 of the terminal of the electrical connecting device of the invention together with the contacting pad 31 of the circuit board form a solder retaining area for retaining enough solder therein, so as to solder the electrical connector to the circuit board efficiently.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector, comprising:
an insulating body having at least one containing hole;
at least one binding pad disposed on the bottom of the insulating body near at least one side of the containing hole; and
at least one terminal correspondingly disposed in the containing hole, the terminal comprising a soldering portion protruding out of the bottom of the containing hole and provided with solder;
wherein a solder retaining area for retaining the solder is formed between the soldering portion and the binding pad.

2. The electrical connector as claimed in claim 1, wherein the binding pad is disposed on both sides of the containing hole.

3. The electrical connector as claimed in claim 1, wherein the binding pad is disposed on a surrounding of the containing hole.

4. The electrical connector as claimed in claim 1, wherein the binding pad is a metal sheet.

5. The electrical connector as claimed in claim 1, wherein a recess interconnecting with the containing hole is disposed at the bottom of the containing hole, and the binding pad is disposed in the recess.

6. A electrical connecting device, comprising:
an electrical connector comprising:
an insulating body having at least one containing hole;
at least one binding pad disposed on the bottom of the insulating body near at least one side of the containing hole; and
at least one terminal correspondingly disposed in the containing hole, the terminal comprising a soldering portion protruding out of the bottom of the containing hole and provided with solder; and
a circuit board connecting with the electrical connector, the circuit board having at least one contacting pad corresponding to the soldering portion of the terminal;
wherein a solder retaining area for retaining the solder is formed among the binding pad, the soldering portion, and the contacting pad.

7. The electrical connecting device as claimed in claim 6, wherein the binding pad is disposed on both sides of the containing hole.

8. The electrical connecting device as claimed in claim 6, wherein the binding pad is disposed on a surrounding of the containing hole.

9. The electrical connecting device as claimed in claim 6, wherein the binding pad is a metal sheet.

10. The electrical connecting device as claimed in claim 6, wherein a recess interconnecting with the containing hole is disposed at the bottom of the containing hole, and the binding pad is disposed in the recess.
